(19) United States
(12) Patent Application Publication
(10) Pub. No.: US 2006/0161753 A1
(43) Pub. Date: Jul. 20, 2006

(54) Method, apparatus and program storage device for providing automatic performance optimization of virtualized storage allocation within a virtualized storage subsystem

(76) Inventors: John G. Aschoff, Watsonville, CA (US); Neena A. Cherian, San Jose, CA (US); Brian J. Smith, San Francisco, CA (US)

Correspondence Address: Chambliss, Bahner & Stophel, P.C., 1000 Tallan Building, Two Union Square, Chattanooga, TN, 37402, US

(21) Appl. No.: 11/037,421

(22) Filed: Jan. 18, 2005

(51) Int. Cl. G06F 12/00

(52) U.S. Cl. 711/170

(57) ABSTRACT

A volume provisioning advisor for managing storage allocation in a plurality of virtual storage subsystems is disclosed. A request for data storage and workload requirements is received from a user. Performance information for storage controllers and managed disks within a virtualization engine is received. Resource groups are defined based on the received performance information and available managed disks, and their utilizations tracked. Resource group performance within the virtualization engine is predicted based on the user workload requirements and existing or historical resource group utilization. Storage is allocated to one or more managed disks within the virtualization engine based on predicted resource group performance.

### BACKGROUND OF THE INVENTION

1. Field of the Invention

This invention relates in general to network storage systems, and more particularly to a method, apparatus and program storage device for providing automatic performance optimization of virtualized storage allocation within a virtualized storage subsystem.

2. Description of Related Art

In enterprise data processing arrangements, such as may be used in a company, government agency or other entity, information is often stored on servers and accessed by users over, for example, a network. The information may comprise any type of information that of programs and/or data to be processed. Users, using their personal computers, workstations, or the like (generally, “computers”) will enable their computers to retrieve information to be processed, and, in addition, to store information, for example, on remote servers.

Generally, servers store data in mass storage subsystems that typically include a number of disk storage units. Data is stored in units, such as files. In a server, a file may be stored on one disk storage unit, or alternatively portions of a file may be stored on several disk storage units. A server may service access requests from a number of users concurrently, and it will be appreciated that it will be preferable that concurrently serviced access operations be in connection with information that is distributed across multiple disk storage units, so that they can be serviced concurrently. Otherwise stated, it is generally desirable to store information in disk storage units in such a manner that one disk drive unit not be heavily loaded, or busy servicing accesses, and while others are lightly loaded or idle.

A computer network of a business may have multiple storage networks that are located remote from one another and a business user. The storage networks may also be hosted on different types of systems. To perform the job correctly, the business user may require fast and reliable access to the data contained in all of the storage networks. Information Technology (IT) employees must be able to provide high-speed, reliable access to the business users.

Storage area networks (SANs) are high-speed, high-bandwidth storage networks that logically connect the data storage devices to servers. The business user, in turn, is typically connected to the data storage devices through the server. SANs extend the concepts offered by traditional server/storage connections and deliver more flexibility, availability, integrated management and performance. SANs are the first IT solutions to allow users access to any information in the enterprise at any time. Generally the SAN includes management software for defining network devices such as hosts, interconnection devices, storage devices, and network attach server (NAS) devices. The SAN management software also allows links to be defined between the devices. Within SANs software can define virtual storage where data is stored across a number of storage disks while being characterized as a single virtual disk.

One important component in reaching this goal of providing high-speed, reliable access to the business users is to allow the SAN to be fully understood by those designing and maintaining the SAN. It is often difficult to quickly understand the SAN due to its complexity. Tools that allow the configuration of the SAN and virtual systems within the SAN to be understood and changed quickly are beneficial.

One of the advantages of a SAN is the elimination of the bottleneck that may occur at a server, which manages storage access for a number of clients. By allowing shared access to storage, a SAN may provide for lower data access latencies and improved performance. However, in a large storage network such as SAN attached storage, it is difficult for a storage administrator to know where to allocate an increment of storage so that the newly allocated space achieves the best possible performance, due to the complexity of the network which can include a number of virtualized storage subsystems, the complexity of analyzing workloads, and that physical storage attributes may be hidden from the application.

In the past, storage allocation for large storage environments has been performed manually. Storage management software that can allocate or recommend where to allocate storage based on a number of algorithms is available. Nevertheless, these algorithms do not actually attempt to satisfy production performance requirements within the constraints of available storage including virtual storage systems within SANs.

It can be seen that there is a need for a method, apparatus and program storage device for providing automatic performance optimization of virtualized storage allocation within a virtualized storage system.

### SUMMARY OF THE INVENTION

To overcome the limitations in the prior art described above, and to overcome other limitations that will become apparent upon reading and understanding the present specification, the present invention discloses a method, apparatus and program storage device for providing automatic performance optimization of virtualized storage allocation within a virtualized storage subsystem.

An embodiment of the present invention includes a program storage device. The program storage devices comprises program instructions executable by a processing device to perform operations for managing storage allocation in a virtual storage system, the operations including defining workload profiles, determining performance characteristics of managed disks, determining relationships between the managed disks and resource groups and creating a virtual disk comprising a set of the managed disks based on resource groups that the managed disks are allocated to.

In another embodiment of the present invention, a device for managing storage allocation in a virtual storage system is provided. The device includes a memory for storing storage system information and a processor coupled to the memory. The processor is configured to provide a user interface for use in defining workload profiles and a virtual disk allocator for determining performance characteristics of managed disks, for determining relationships between managed disks and resource groups based on user defined or automated inputs and for creating a virtual disk comprising a set of the managed disk considering the resource groups to which the managed disks are allocated.

In another embodiment of the present invention, a method for managing storage allocation in a virtual storage system is provided. The method includes obtaining user defined workload profiles, determining performance characteristics of managed disks, determining relationships between managed disks and resource groups based on user defined or automated inputs, and creating a virtual disk comprising a set of the managed disk considering the resource groups to which the managed disks are allocated.

In another embodiment of the present invention, a volume provisioning advisor for managing storage allocation in a virtual storage system is provided. The volume provisioning advisor includes a user interface for use in defining workload profiles and a virtual disk allocator, operatively coupled to the user interface, the virtual disk allocator determining the performance characteristics of managed disks, determining relationships between managed disks and resource groups based on user defined or automated inputs and creating a virtual disk comprising a set of the managed disks considering the resource groups to which the managed disks are allocated.

In another embodiment of the present invention, another volume provisioning advisor is provided. This embodiment of a volume provisioning advisor includes means for obtaining user defined workload profiles, means for determining performance characteristics of managed disks, means for determining relationships between managed disks and resource groups based on user defined or automated inputs, and means for creating a virtual disk comprising a set of the managed disk considering the resource groups to which the managed disks are allocated.

In another embodiment of the present invention, another volume provisioning advisor is provided. This embodiment of a volume provisioning advisor includes means for obtaining user defined workload profiles, means for determining performance characteristics of managed disks and means for creating a virtual disk comprising a set of the managed disk considering the resource groups to which the managed disks are allocated.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a computer network in the form of a local area network;

FIG. 2 shows one embodiment of a storage area network according to an embodiment of the present invention;

FIG. 3 illustrates a table of attributes incorporated into the virtual disk allocator according to an embodiment of the present invention;

FIG. 4 illustrates mechanisms for a user interface to obtain workload profiles for use by the virtual disk allocator in allocating managed disks to resource groups according to an embodiment of the present invention;

FIG. 5 illustrates mechanisms for determining the performance capabilities of managed disks;

FIG. 6 illustrates a data structure used by the virtual disk allocator to abstract the important performance elements in a virtualized storage subsystem according to an embodiment of the present invention; and

FIG. 7 illustrates a flow chart of the method for managing storage allocation in a virtual storage system according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing automatic performance optimization of virtualized storage allocation within a virtualized storage subsystem.

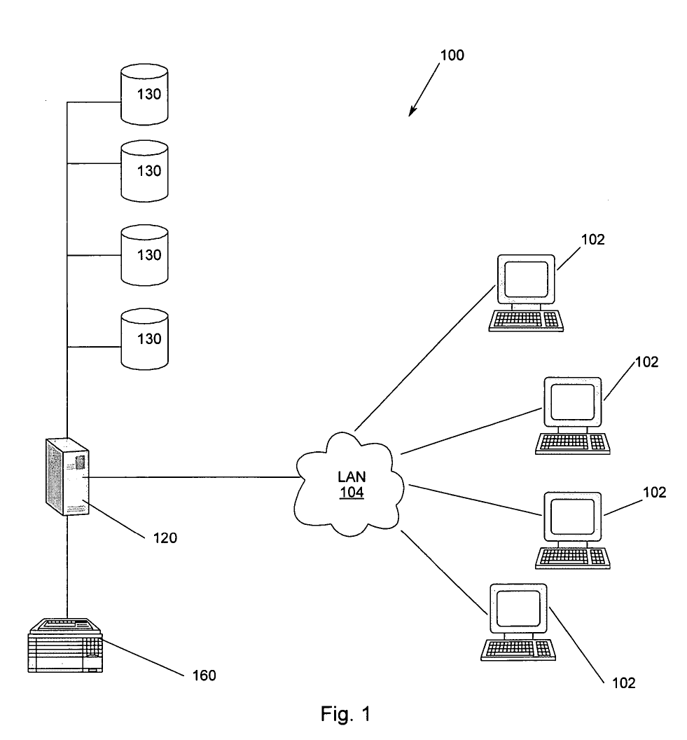

FIG. 1 illustrates a computer network 100 in the form of a local area network (LAN). In FIG. 1, workstation nodes 102 are coupled to a server 120 via a LAN interconnection 104. Data storage 130 is coupled to the server 120 via data bus 150. LAN interconnection 100 may be any number of network topologies, such as Ethernet.

The network shown in FIG. 1 is known as a client-server model of network. Clients are devices connected to the network that share services or other resources. A server 120 administers these services or resources. A server 120 is a computer or software program, which provides services to clients 102. Services that may be administered by a server include access to data storage 130, applications provided by the server 120 or other connected nodes (not shown), or printer sharing 160.

In FIG. 1, workstations 102 are clients of server 120 and share access to data storage 130 that is administered by server 120. When one of workstations 102 requires access to data storage 130, the workstation 102 submits a request to server 120 via LAN interconnect 100. Server 120 services requests for access from workstations 102 to data storage 130. Possible interconnect technologies between server and storage are Fibre Channel protocol (FCP) or small computer systems interface (SCSI).

As networks such as shown in FIG. 1 grow, new clients 102 may be added, more storage 130 may be added and servicing demands may increase. As mentioned above, server 120 will service all requests for access to storage 130. Consequently, IO load on storage 130 may increase dramatically, and the workload on server 120 may increase dramatically resulting in the possibility of performance decline. To help reduce the bandwidth limitations of the traditional client server model, Storage Area Networks (SAN) have become increasingly popular in recent years. Storage Area Networks interconnect servers and storage at high speeds. By combining existing networking models, such as LANs, with Storage Area Networks, performance of the overall computer network may be improved.

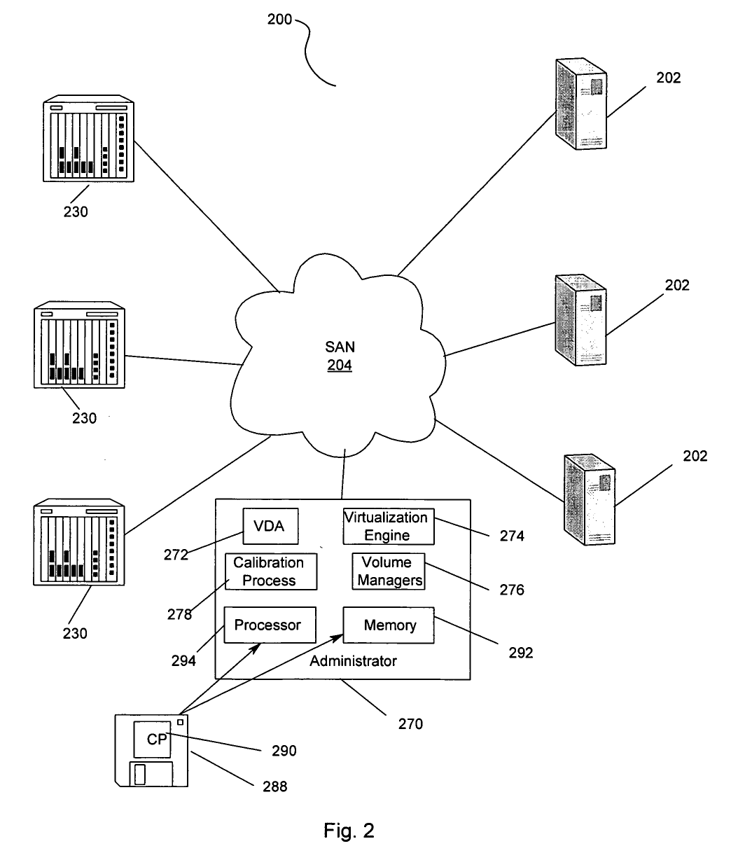

FIG. 2 shows one embodiment of a SAN 200 according to an embodiment of the present invention. In FIG. 2, servers 202 are coupled to data storage devices 230 via SAN interconnect 204. Each server 202 and each storage device 230 is coupled to SAN interconnect 200. Servers 202 have direct access to any of the storage devices 230 connected to the SAN interconnect. SAN interconnect 200 can be a high speed interconnect, such as Fibre Channel or SCSI. As FIG. 2 shows, the servers 202 and storage devices 230 comprise a network in and of themselves.

In the SAN 200 of FIG. 2, no server 202 is dedicated to a particular storage device 230 as in a LAN. Any server 202 may access any storage device 230 on the SAN 200 in FIG. 2. Typical characteristics of a SAN 200 may include high bandwidth, a multitude of paths from server to storage nodes, a large connection distance, and a very large storage capacity. Consequently, with the complexity of SAN, the performance, flexibility, and scalability of a Fibre Channel-based SAN 200 may be significantly greater than that of a typical SCSI based system.

FIG. 2 also shows a network administrator 270 coupled to the SAN interconnect 204. Effectively allocating storage 230 in a SAN 200 in a manner that exploits all available SAN resources, from disks to data paths, and that provides for adequate data protection and recoverability is of particular importance. The administrator 270 may be configured to aid in the selection of storage locations within a large network of storage elements. The administrator 270 includes a virtual disk allocator 272 that, according to an embodiment of the present invention, processes input/output storage allocation in accordance with a customer's specified performance and space requirements, given a level of desired performance, attributes of the user's workload, the varying performance attributes of storage and its response to different types of workloads, and the presence of competing workloads within the network.

The virtual disk allocator 272 satisfies requests for storage within the network of storage elements in such a way as to meet the performance requirements specified with the request, or through a storage policy mechanism. The virtual disk allocator 272 can operate in environments such as IBM 2145 SAN Volume Controller (SAN VC), which is a virtualized storage subsystem. The virtual disk allocator 272 determines performance characteristics of managed disks. The virtual disk allocator 272 determines relationships between managed disks and resource groups based on user defined or automated input, and creates a virtual disk that includes a set of the managed disks, taking into consideration the resource groups, and the resource group storage resources such as cache and data paths, to which the managed disks are allocated.

The virtual disk allocator 272 extends the policy-based aspects to Open System Environments and automates the selection of storage elements within virtualized storage subsystems to meet performance requirements. Recommending the selected storage elements within the virtualized storage system allows for optimal usage of striped or composite volumes supported by the OS or Volume Manager software, or applications (such as database applications) which support the concept of striped volumes, such as DB2 and other database products The virtual disk allocator 272 also extends the notions of allocating storage taking into consideration long-term data usage patterns. The virtual disk allocator 272 incorporates various algorithms required to make intelligent choice of data placement.

The virtual disk allocator 272 may make determinations of which nodes, i.e., engines such as the virtualization engine 274, may access the data, and which managed disk groups (MDGs), groups of disks supporting a virtual disk, would compose the LUNs to be selected. Within the MDG is at least one managed disk, which is used by a virtualization engine 274 and volume manager 276 to stripe data within the virtual disk, which is comparable to logical disks in Enterprise Storage Systems (ESS). The virtual disk allocator 272 can thus select a LUN or a plurality of LUNs in multiple resource groups across multiple storage elements in order to meet the customer's desired level of performance.

The administrator may perform a calibration process 278 to discover the performance capabilities of the underlying disks. This would entail running specific tests to discover the performance parameters of those groups of disks, as opposed to merely using specific knowledge about the performance capabilities of the disks organized in specific configurations in resource groups.

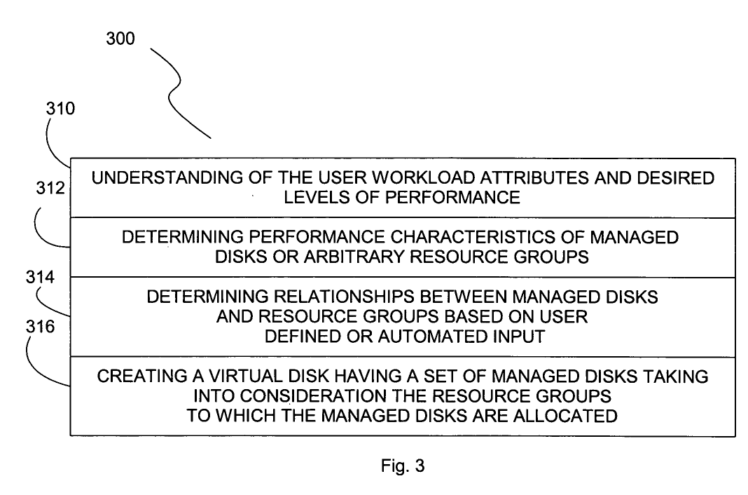

FIG. 3 illustrates a table 300 of attributes incorporated into the virtual disk allocator 272 according to an embodiment of the present invention. These include understanding of the user workload attributes and desired levels of performance 310, determining performance characteristics of managed disks or arbitrary resource groups 312, determines relationships between managed disks and resource groups based on user defined or automated input 314, and creating a virtual disk having a set of managed disks 316, taking into consideration the resource groups to which the managed disks are allocated.

It is almost impossible to make intelligent data placement decisions without having a rudimentary understanding of the application workload requirements, or at least making reasonable assumptions about those workloads. For example, if a user asks for 100 GB of storage, a light performance requirement might allow allocating a single 100 GB logical disk, whereas a high performance application might require allocating ten 100 GB logical disks across 10 disk arrays, and striping of data across those logical disks. Unfortunately, when most customers are asked what their workloads look like, they usually have no idea.

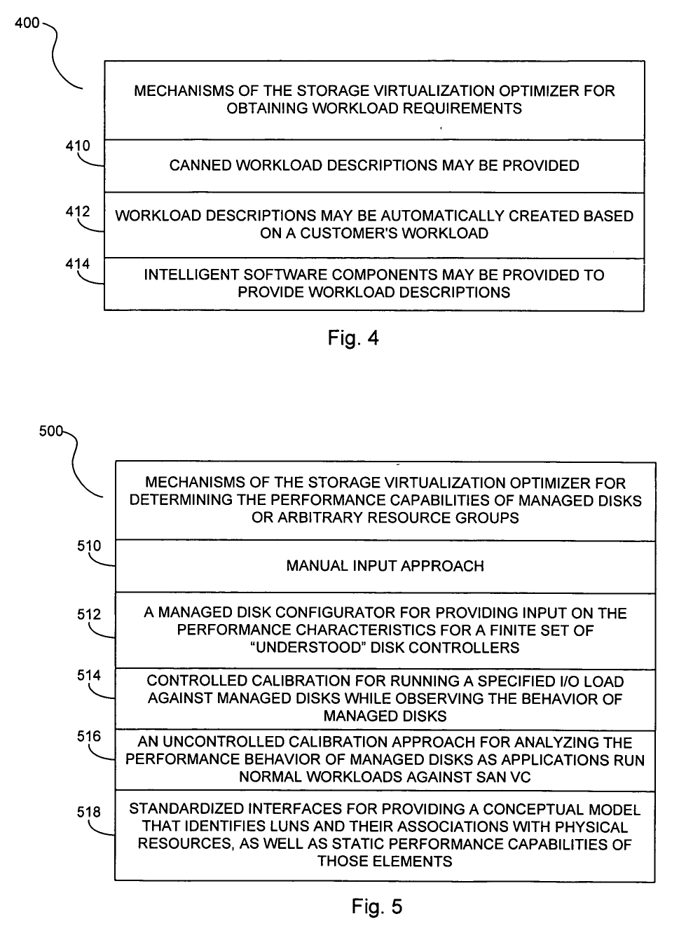

FIG. 4 illustrates mechanisms 400 for a user interface to obtain workload profiles for use by the virtual disk allocator 272 in allocating managed disks to resource groups according to an embodiment of the present invention. Workload profiles describe characteristics of the workload and desired level of throughput and can include information such as quantity of desired storage and allocation hints.

First, canned workload profiles may be provided 410. Referring to FIG. 2, the virtual disk allocator 272 may provide canned workload profiles in memory 292. The canned workload profiles 410 may be based on characterizations of customer environments across various industries and applications. As examples, a set of named canned workloads, e.g., SAP_OLTP, DB2 Business Intelligence, etc., may be provided. With some advice from an application specialist, the customer initially selects one of these canned workloads 410.

Workload profiles may also be automatically created based on observations of a customer's workload 412. Since every customer's workload has unique attributes, better workload assumptions can be obtained by observing storage access patterns in the customer's environment. Referring to FIG. 2, the virtual disk allocator 272 may base many of its decisions on observed disk access behavior, which it maintains in memory 292 in the form of a database. A user interface, such as a graphic interface, cooperatively coupled to virtual disk allocator 272, allows a user to point to a grouping of volumes and a particular window of time, and then create a workload profiles based on the observed behavior of those volumes. In this way, the virtual disk allocator 272 learns about a customer's workload, and enhances its decision-making over time. Alternatively, the user interface can be a scripted application using the command line interface (CLI).

Workload profiles may also be provided by intelligent software components 414. Referring to FIG. 2, the virtual disk allocator 272 may also include intelligent software components to provide workload profiles. These workload profiles may be based on special knowledge inherent in an application.

FIG. 5 illustrates mechanisms 500 for determining the performance capabilities of managed disks or arbitrary resource groups, hereinafter managed disks. Managed disk performance capabilities are used by virtual disk allocator 272 along with workload profiles to allocate the managed disks to resource groups. Such mechanisms range from manual input from an administrator, to automated heuristics for deriving performance capabilities. Within the range include mechanisms for determining performance using the calibration of capabilities by use of a calibration workload, either in a controlled or an uncontrolled storage environment.

One mechanism for determining the performance capabilities of managed disks includes a manual input approach 510. This approach is a simple, but less desirable approach to understanding managed disk performance capabilities. For example, a small number of managed disk performance profiles could be defined (e.g., “mirrored disk”, “RAID-5 array with 8 disks.” Each of these profiles would have specific default performance attributes. The administrator would then select the appropriate profile that matches the managed disk configuration. This approach would narrow some of the very wide differences in managed disk performance capability.

Another approach to understanding the performance capabilities of managed disks involves a managed disk configurator 512. Device-specific configurators could provide input on the performance characteristics for a finite set of “understood” disk controllers and the relationship between the managed disks and the storage controllers. For example, a FAStT900 configurator could provide a uniform technique of creating RAID arrays, LUNs, and managed disk on a subsystem, and then provide the managed disk performance assumptions for those managed disk. Configurators could also dynamically recognize the relationship between the managed disk and the storage controllers.

In another approach, controlled calibration 514 is used to run a specified I/O load against the managed disks while observing the behavior of managed disks. Ordinarily, controlled calibration would be executed before space is allocated on the managed disks, although it could be executed afterward if space were reserved.

In an uncontrolled calibration approach 516, the performance behavior of managed disks is analyzed as applications run normal workloads against managed disks. This approach would be used if managed disks were already assigned (and there is no free space reserved for calibration). It is also useful to determine if conditions have changed since the controlled calibration step (e.g., the managed disk is running in degraded condition). As an example, the uncontrolled calibration might observe that response times are consistently high at particular load points, assuming that this load point more accurately reflects the maximum throughput capability.

Another approach uses standardized interfaces 518 which may allow the SMIS specification to provide a conceptual model that identifies LUNs and the LUN's associations with physical resources, as well as static performance capabilities of those elements.

Other approaches similar to those mentioned above can be used to make allocation decisions. Similarly, combinations of the above-mentioned approaches can be chosen. For example, administrators might choose to run a controlled calibration step against the first storage controller of a particular type configured behind the SAN VC, and then manually assign attributes for subsequent controllers of that same type, e.g., “these managed disks look just like those managed disks”.

The workload parameters used by the virtual disk allocator 272 are selected based on their ability to accurately predict disk storage performance, and based on their general availability though data collection tools. The workload parameters used include maximum throughputs for each of the managed disks, maximum random reads and writes per second, maximum mixed reads and writes per second, maximum sequential reads and writes per second, maximum mixed sequential reads and writes per second and latency at low and maximum loads.

Mixed reads and writes are important to determine whether the component has bidirectional capability. The short block random operations are used to determine processing capabilities and costs, and the large block sequential metrics are used to determine data transfer capabilities and costs.

These maximum throughputs are then used to determine the overhead per read or write operation, and per read or write megabyte transferred. The overheads are then applied to the projected workload characteristics to determine projected utilizations of the managed disks.

Because managed disks have individual performance capabilities, and have different performance capabilities when taking into account the performance capabilities of other resources associated with those managed disks, the virtual disk allocator 272 defines resource groups, each having associated performance attributes for a set of managed disks that belong to the resource group. By taking into account the managed disk performance capabilities and the performance capabilities of their associated resources, the overall performance of the managed disks can be determined. These other resources might include the physical disks or controllers on which the managed disks reside. However, it is not necessary to identify all of the possible resources associated with the managed disks. Instead, the virtual disk allocator 272 will generalize associations with resources when defining a resource group.

Each resource group is given performance attributes (same as for managed disks). The performance capacity of resource groups can be specified manually or determined through a controlled benchmark procedure called controlled calibration. Calibration can be executed against managed disks identified and at a time identified by an administrator. The calibration may be executed against managed disks before they are assigned to virtual disks. This could also be contained within an operational procedure that automates creation of managed disks on specified storage controllers. The calibration would be executed against individual managed disks and all of the associated resource groups as long as all of the managed disks in the groups are not assigned. The technique used in calibration is similar to those used in conducting engineering measurements against competitive disk subsystems.

Because managed disks can belong to more than one resource group, calibration of resource groups allows optimization of data allocation decisions. However, it is not necessary to discover all of the potential relationships between managed disks and associated resources, and no impact results when suspected relationships do not exist. Various implementations of the virtual disk allocator 272 could build-in varying levels of sophistication in discovering the relationships.

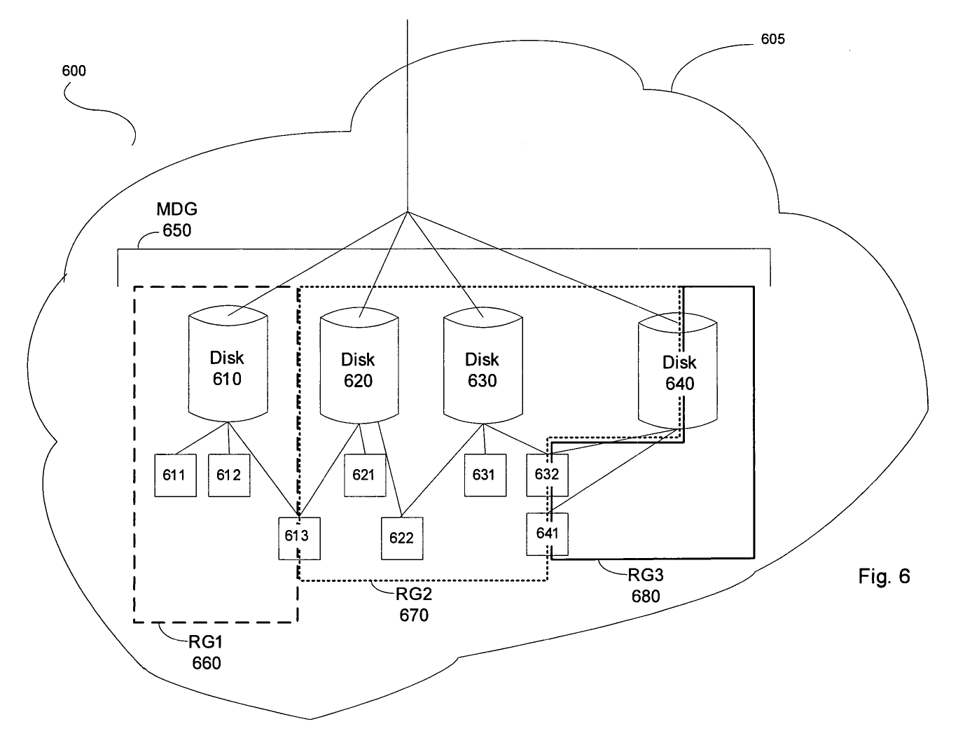

FIG. 6 illustrates a data structure 600 used by the virtual disk allocator 272 to abstract the important performance elements in a virtualized storage subsystem according to an embodiment of the present invention. The data structure may be represented as a tree of nodes representing storage elements such as clusters, device adapters, individual disks or disk arrays and any associated resources. However, those skilled in the art will recognize that the present invention is not meant to be limited to the structure shown in FIG. 6. Rather, a more general network of nodes than a tree structure may be used.

Data structure 600 is used to provide a goal-oriented approach to storage allocation. As an example, the SAN VC presents a somewhat different model of storage than the traditional storage controller. The application server is presented with a view of virtual disks, comparable to logical disks in IBM Enterprise Storage Servers (ESS). Virtual disk allocator 272 creates a virtual disk by identifying a set of performance properties associated with a set of managed disks and resource groups, including throughput capabilities for specific workloads and estimating resource utilization derived from the identified set of performance properties associated with a set of managed disks and resource groups. A virtual disk is accessed, for example, through a SAN VC primary node, and data for the virtual disk is cached in that node, a function comparable to an ESS cluster. Referring to FIG. 6, the storage for the virtual disk 605 is allocated across one or more managed disks 610, 620, 630 and 640. The managed disks illustrated are grouped into a managed disk group (MDG) 650. Virtual disk 605 is associated with a single MDG 650. Typically, for best performance, virtual disk 605 would be striped across all of the managed disks in the MDG 650.

Each of the managed disks 610, 620, 630 and 640 might be allocated as a portion of a single physical disk shared with other applications, or allocated as an entire RAID array consisting of several disks. In addition, storage administrators are given tremendous flexibility in selection of managed disk configurations. As a result of associations with other applications, activity on one managed disk can affect the performance of another managed disk, such as when they reside on the same storage device or behind the same storage controller. With reference to FIG. 6, managed disk 610 is associated with three resources 611, 612, and 613, while managed disk 620 is associated with resources 613, 621 and 622. Because resource 613 is associated with both managed disk 610 and 620, each of the managed disk's performance characteristics may be unknown and highly variable. Thus, the key to intelligent data placement decisions is acquiring and maintaining reasonable performance assumptions about the capability and behavior of a managed disk.

In accordance with an embodiment of the invention, each managed disk is associated with one or more resource groups (RGs). RG 1 660, RG 2 670 and RG 3 680 are defined by the virtual disk allocator 272. RG1 660 includes managed disk 610 and resources 611, 612 and 613. RG2 670 includes managed disk 620, 630 and a portion of managed disk 640, and has resources 613, 621, 622, 631, 632 and 641. RG3 680 includes a portion of managed disk 640, and resources 632 and 641. As can be seen, resource 613 is shared between managed disk 610 and 620, and resources 632 and 641 are shared between managed disk 630 and 640. Because managed disks and associated resources are grouped into resource groups allowing observation of interactions within and between resource groups, enhanced performance assumptions about the capability and behavior of the managed disks can be made by virtual disk allocator 272.

For example, during the volume selection process, the virtual disk allocator 272 keeps track of utilizations of managed disks and resource groups, similar to the way it maintains those utilizations for the components of the configuration tree in VPA for ESS. When selecting potential managed disks for allocation, the effects are evaluated for all of the resource groups to which a managed disk belongs. The managed disk's utilization is then assumed to be the highest of all the associated RGs. This is similar to the technique of navigating up the configuration tree used by the current version of VPA. The virtual disk allocator 272 makes a recommendation for storage allocation that meets the capacity and the performance requirements specified.

Referring again to FIG. 2, the virtual disk allocator 272 improves with knowledge about how the storage elements are actually performing, but does not depend on extremely accurate information, which is why the virtual disk allocator 272 can work for heterogeneous types of storage from different vendors. But accurate real-time or historical performance data can be used to differentiate one vendor's products from others, as well as biasing storage allocations away from workloads that are likely to compete during the time periods of interest.

An important aspect of the virtual disk allocator 272 involves the use of the capacity and performance structures to balance storage allocation across available resources. Where multiple choices are possible in virtual disk allocator 272, the capacity and performance structures may be used to bias allocation to one set of resources through the use of pseudo-random numbers. Several sample allocations can be selected in this fashion, and the best among the samples chosen for the answer. This technique prevents the algorithms from making the same recommendation in similar situations, increasing the spread of workloads across available resources. In this way, storage allocations will be biased toward elements in the network that are most capable of handling the specified workload.

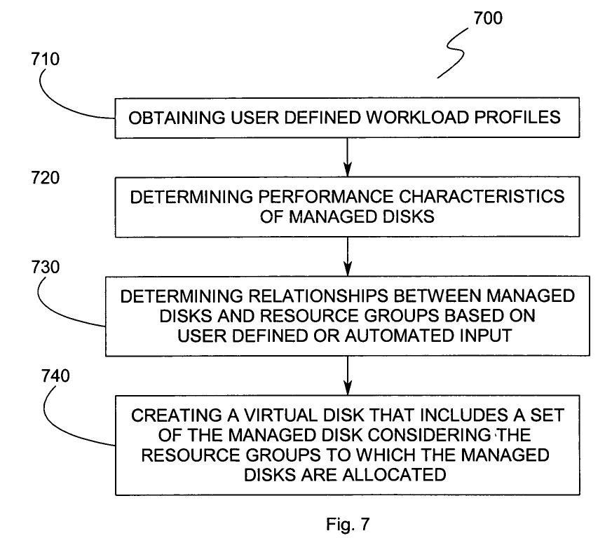

FIG. 7 illustrates a flow chart 700 of the method for managing storage allocation in a virtual storage system according to an embodiment of the present invention. The method includes obtaining user defined workload profiles 710 and determining performance characteristics of managed disks 720. Relationships between managed disks and resource groups are determined based on user defined or automated input 730. A virtual disk is created that includes a set of the managed disk considering the resource groups to which the managed disks are allocated 740.

The process illustrated with reference to FIGS. 3-7 may be tangibly embodied in a computer-readable medium or carrier, e.g. one or more of the fixed and/or removable data storage devices 288 illustrated in FIG. 2, or other data storage or data communications devices. The data storage device 288 or computer program 290 may be loaded into memory 292 to configure the administrator 270 or virtual disk allocator 272 for execution. Such computer programs include instructions which, when read and executed by a processor, such as processor 294 of FIG. 2, causes the administrator 270 or virtual disk allocator 272 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A program storage device, comprising:
program instructions executable by a processing device to perform operations for managing storage allocation in a virtual storage system, the operations comprising:
defining workload profiles;
determining performance characteristics of managed disks;
determining relationships between the managed disks and resource groups; and
creating a virtual disk comprising a set of the managed disks based on resource groups that the managed disks are allocated to.

2. The program storage device of claim 1, wherein the determining relationships is based on user input.

3. The program storage device of claim 1, wherein the determining relationships is based on automatically provided input.

4. The program storage device of claim 1, wherein the creating a virtual disk further comprises creating a plurality of virtual disks within the set of managed disks based on the resource groups to which the managed disks are allocated.

5. The program storage device of claim 1 further comprising:
selecting locations for virtual disks by identifying a set of performance properties associated with a set of managed disks and resource groups including throughput capabilities for specific workloads; and
estimating optimal resource utilization based on performance properties associated with a set of managed disks and resource groups.

6. The program storage device of claim 1, wherein the defining workload profiles further comprises selecting at least one selected from the group consisting of quantity of desired storage, identification of characteristics of the workload and desired level of throughput, and allocation hints.

7. The program storage device of claim 1 further comprising obtaining performance capabilities of managed disks.

8. The program storage device of claim 7, wherein the obtaining performance capabilities of managed disks further comprises providing manual input indicating performance capabilities of managed disks.

9. The program storage device of claim 7, wherein the obtaining performance capabilities of managed disks further comprises receiving performance capabilities from a managed disk configurator.

10. The program storage device of claim 9, wherein the receiving performance capabilities from a managed disk configurator further comprises obtaining information on the performance characteristics of managed disks and their associated resource groups, wherein the resources groups identify potential relationships between managed disks.

11. The program storage device of claim 7, wherein the obtaining performance capabilities of managed disks further comprises performing a controlled calibration and using the results from the controlled calibration.

12. The program storage device of claim 11, wherein the performing a controlled calibration comprises running a specified I/O load against the managed disks to identify behavior of the managed disks.

13. The program storage device of claim 7, wherein the obtaining performance capabilities of managed disks further comprises performing an uncontrolled calibration and using the results from the uncontrolled calibration.

14. The program storage device of claim 9, wherein the performing an uncontrolled calibration comprises analyzing the performance behavior as applications run as uncontrolled workloads to identify behavior of the managed disks.

15. The program storage device of claim 7, wherein the obtaining performance capabilities of managed disks further comprises receiving input from a user through an interface.

16. The program storage device of claim 1, wherein the determining performance characteristics of managed disks further comprises identifying resource groups the managed disks belong to.

17. A device for managing storage allocation in a virtual storage system, comprising:
memory for storing storage system information;
a processor, coupled to the memory, the processor being configured for providing a user interface for use in defining workload profiles and a virtual disk allocator for determining the performance characteristics of managed disks, determining relationships between managed disks and resource groups based on user defined or automated inputs and creating a virtual disk comprising a set of the managed disks considering the resource groups to which the managed disks are allocated.

18. The device of claim 17, wherein the processor creates one or more virtual disks within the set of managed disks considering the resource groups to which the managed disks are allocated.

19. The device of claim 17, wherein the processor allocator recommends locations for virtual disks by identifying a set of performance properties associated with a set of managed disks and resource groups including throughput capabilities for specific workloads and estimating optimal resource utilization based on performance properties associated with a set of managed disks and resource groups.

20. The device of claim 17, wherein the workload profiles comprise at least one selected from the group consisting of quantity of desired storage, identification of characteristics of the workload and desired level of throughput, and allocation hints.

21. The device of claim 17, wherein the processor provides a graphic interface.

22. The device of claim 17, wherein the processor provides a scripted application using a command line interface.

23. The device of claim 17, wherein the processor provides a scripted application using an application programming interface (API)).

24. The device of claim 17, wherein the processor determines performance capabilities of managed disk using at least one from the group comprising manual input, a managed disk configurator, controlled calibration results, uncontrolled calibration results and standard interface input.

25. The device of claim 24, wherein the manual input comprises a selection from performance profiles of managed disks.

26. The device of claim 24, wherein the manual input comprises a selection from performance profiles resource group.

27. A method for managing storage allocation in a virtual storage system, comprising:
obtaining user defined workload profiles;
determining performance characteristics of managed disks;
recommending allocation of virtual disks comprising a set of the managed disks considering the resource groups to which the managed disks are allocated.

28. The method of claim 27 further comprising creating a virtual disk comprising a set of the managed disk considering the resource groups to which the managed disks are allocated.

29. The method of claim 28, wherein creating a virtual disk further comprises identifying a set of performance properties associated with a set of managed disks and resource groups including throughput capabilities for specific workloads and estimating resource utilization derived from the identified set of performance properties associated with a set of managed disks and resource groups.

30. The method of claim 27, wherein the obtaining user defined workload profiles further comprise selecting at least one from the group consisting of quantity of desired storage, identification of characteristics of the workload and desired level of throughput, and allocation hints.

31. The method of claim 27, wherein the determining performance capabilities of managed disk comprises using at least one from the group consisting of manual input, obtain configuration data, controlled calibration results, uncontrolled calibration results and standard interface input.

32. A volume provisioning advisor for managing storage allocation in a virtual storage system, comprising:
a user interface for use in defining workload profiles; and
a virtual disk allocator, operatively coupled to the user interface, the virtual disk allocator determining the performance characteristics of managed disks, determining relationships between managed disks and resource groups based on user defined or automated inputs and creating a virtual disk comprising a set of the managed disks considering the resource groups to which the managed disks are allocated.

33. The volume provisioning advisor of claim 32, wherein the workload profiles comprise at least one selected from the group consisting of quantity of desired storage, identification of characteristics of the workload and desired level of throughput, and allocation hints.

34. The volume provisioning advisor of claim 32, wherein a resource group comprises a name, performance attributes and a set of managed disks that belong to the resource group.

35. The volume provisioning advisor of claim 32, wherein a managed disk belongs to one or more resource group, wherein a resource groups identifies potential relationships among managed disks.

36. A volume provisioning advisor for managing storage allocation in a virtual storage system, comprising:
means for obtaining user defined workload profiles;
means for determining performance characteristics of managed disks; and
means for recommending allocation of virtual disks comprising a set of the managed disks considering the resource groups to which the managed disks are allocated.

37. A volume provisioning advisor for managing storage allocation in a virtual storage system, comprising:
means for obtaining user defined workload profiles;
means for determining performance characteristics of managed disks; and
means for creating a virtual disk comprising a set of the managed disk considering the resource groups to which the managed disks are allocated.
